(19) United States
(12) Patent Application Publication
(10) Pub. No.: US 2017/0335445 A1
(43) Pub. Date: Nov. 23, 2017

(54) METHOD OF CASE HARDENING GEARS

(71) Applicants: Anatoly Alexeevich Kuznetsov, Moscow (RU); Arkadiy Moiseevich Peker, Odintsovo Moskovskaya (RU); Semyon Brayman, West Bloomfield, MI (US); Nikolay Igorevich Mironov, Moscow (RU)

(72) Inventors: Anatoly Alexeevich Kuznetsov, Moscow (RU); Arkadiy Moiseevich Peker, Odintsovo Moskovskaya (RU); Semyon Brayman, West Bloomfield, MI (US); Nikolay Igorevich Mironov, Moscow (RU)

(21) Appl. No.: 15/592,501

(22) Filed: May 11, 2017

Related U.S. Application Data
(60) Provisional application No. 62/335,224, filed on May 12, 2016.

(51) Int. Cl. C23C 8/04; C21D 1/06; F16H 55/06; F16H 55/17

(52) U.S. Cl. CPC C23C 8/04; F16H 55/06; C21D 1/06; F16H 55/17

(57) ABSTRACT

A method of case hardening toothed gearing using low (LH) or specified hardness (SH) steel and using through surface hardening (TSH) in order to create a described case hardening pattern which increases the fatigue strength of the gear tooth.

### CROSS REFERENCE TO RELATED APPLICATIONS

This patent claims the benefit of provisional application U.S. Ser. No. 62/335,224, filed on May 12, 2016.

### BACKGROUND OF THE INVENTION

The present invention pertains to hardening of complex contoured parts such as gear train components of rear, front and middle axles, gearboxes, reduction gears of self-propelled machines and various mechanisms that consist of a drive, follower, idler and satellite components in combination with volute gears, including tooth couplings and pinions, ETC., produced from to hardenability (LH) and specified hardenability (SH) steels and thermally treated to achieve through-surface hardening (TSH).

Typical parts hardened using TSH are ring gears, shaft and axle hole mounting surfaces, loaded sections of pinions, bearings, external and internal spline elements.

The TSH method and LH steels have been used, successfully in the Russian Federation countries and other countries to produce average modulus (6-10 mm) drive and follower gears.

The 55LH, 60LH and IIIX SH steel grades which have been used have the disadvantage that the steel hardenability required for a specific cross section was achieved by a drastic reduction of all permanent admixtures (Mn, Si, Cr, Ni, Cu and others) or by empiric selection of the chemical composition thereof. This made selection of the appropriate LH or SH steel difficult and resulted in a lesser accuracy of the desired hardened layer depth and its wider variation.

### SUMMARY OF THE INVENTION

The present invention utilizes LH and SH steels with rapid quenching processes to produce gears which have surfaces hardened in an advantageous pattern so as to achieve a high fatigue strength. This is accomplished for three different categories of gears, category I, which is heavy duty gears of a gear modulus greater than 5 mm, category II, which is heavy duty gears of a gear modulus ranging atom 3.0-4.5 mm, and category III which is medium duty gears of a gear modulus ranging from 3 to 4.5 mm.

For each of these categories there is a mathematical relationship drawn between the D_{cr} of the LH and SH steel used to make the gears and the gear modulus, which gears when hardened with a through surface hardening process (TSH) involving rapid quenching in water has been found to create a described advantageous hardening pattern on the gear teeth.

Improved LH and SH steels as described in U.S. publication 2015/0232969, incorporated herein by reference when rapidly quenched to produce gear train components enables more accurate selection of the steel chemical composition in conformity with its calculated narrow ideal critical hardening diameter(D_{cr.})and the normal gear tooth modulus (m). With the same carbon content and ideal steel critical hardening diameter, the presence or absence of other alloying elements or permanent admixtures within the range of values indicated in the afore-mentioned patents and published patent application has practically no influence on the mechanical properties of the steel being used.

Structural and service strength of gear train components made from those LH and SH steels and subjected to TSH is not less, but in some cases even 1.5 to 2 times higher than that of alloyed carburized steels.

The machinability of LH and SH steels with 0.60% to 0.80% carbon, after normalization, on lathes is similar to that of widely used carbon steel with 0.45% carbon and not inferior to alloyed carburized chrome-manganese and chrome-nickel steels.

The reason for higher static strength and impact viscosity of LH and SH steels after TSH, compared to carburized steels, lies in the fact that, thanks to rapid induction heating and specific deoxidation during smelting, LH and SH steels have considerably finer austenite grains (10-12) than carburized steels (7-9); higher fatigue strength is also explained by higher residual compression stresses in the hardened surface layer of LH and SH steels, compared to carburized steels.

In addition, through-surface hardening of components made from those LH and SH steels is a less labor-intensive and more environmentally friendly process than thermochemical treatment and oil quenching, as the heating process is dozens of times faster than during thermochemical treatment and water is used for intensive cooling. This helps to reduce component deformation and warping because rapid heating completely rules out steel creeping and turbulent flow of quenching water ensures more uniform cooling of the entire surface.

Depending on the content of alloying elements, the cost of LH and SH steels is about 1.5 to 2 times lower than that of alloyed carburized steels and is similar to conventional carbon steel.

### DESCRIPTION OF THE DRAWINGS

FIG. 1 is a diagram of three categories of gear teeth which are case hardened to produce respective patterns produced by the method according to the present invention.

FIG. 2 is a diagram of an arrangement for testing the hardness of gear teeth achieved by the case hardening process according to the invention.

### DETAILED DESCRIPTION

In the following detailed description, certain specific terminology will be employed for the sake of clarity and a particular embodiment described in accordance with the requirements of 35 USC 112, but it is to he understood that the same is not intended to be limiting and should not be so construed inasmuch as the invention is capable of taking many forms and variations within the scope of the appended claims.

Gear teeth are, in majority of cases, the most loaded elements. At maximum drive mechanism torque, the teeth are the first to experience fatigue breakages caused by bending stresses at the tooth radius near the roots. Hence, the bending fatigue strength of gear train components is the determinative factor.

A gear tooth represents a variable cross section plate whose thickness at the bottom and top are almost equal (2-12) m, where the normal gear modulus. One side of the plate is fixed at the cylinder bottom along the tooth root diameter and experiences bending stresses.

Therefore, in order to achieve the maximum plate strength during bending after TSH [reference 3] the hardened layer depth at the tooth radius and in the roots between the teeth are selected to be (0.1-0.2)δᵣ of the tooth radius thickness(δᵣ), i.e. δᵣ=(0.2-0.44)m.

Optimum hardened layer depth limits in the root and at the tooth radius shown, in prototype are narrower (0.18-0.28)m because it is mostly focused on contact strength.

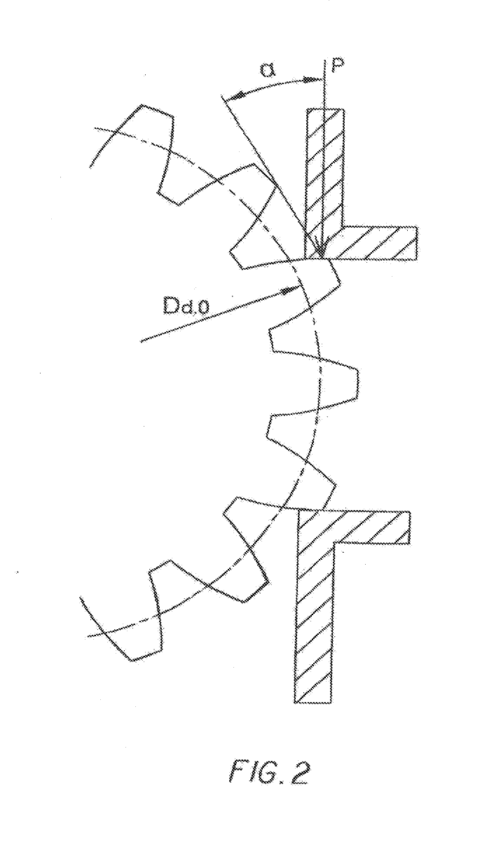

According to the single tooth and bench test data, (see FIG. 2 and examples 1, 2, 3 below):

the calculated ultimate tooth bending strength results turned out to be very close: 740 N/mm² during single tooth machine tests and 600 N/mm² during closed-loop bench tests;

long-term bending and contact stresses for gear teeth with modulus m>5 mm in the vicinity of the ultimate fatigue strength σ_{b}=400-600 N/mm² or during higher short-term stresses—category I;

long-term bending stresses for gears with modulus m<5 mm. i.e. 3-4.5 mm, in the vicinity of the ultimate fatigue strength σ_{b}=300-600 N/mm² without overloading, are heavy-duty—categoryII; due to smaller tooth size, these gears are, as a rule, used in gear trains that experience smaller stresses compared to category I gears;

bending stresses of gears with modulus under 5 mm at stresses σ_{b}<300 N/mm² are medium-heavy—category III.

In order to achieve high contact strength the total hardened layer depth before half-martensite (50% martensite+50% troostite) in the pitch line diameter zoneΔₚₗ must be within the Δₚₗ=(0.15-0.2)δₚₗ range (δₚₗ is the tooth thickness along the pitch line; δₚₗ ≈1.57 m), i.e. Δₚₗ=(0.23-0.32)m. Here in order to increase the contact strength the lower Δₚₗ=0.15δₚₗ limit was raised compared to the bending strengthΔ_{b}=0.1δᵣ, but due to thermo-physical conditions of rapid cooling [6] used during TSH, growth of this ratio beyond Δₚₗ>(0.2-0.25)δₚₗ will result in spontaneous through hardening of the teeth in this zone and their potential brittle failure during operation.

This is why the Δₚₗ=(0.32)m value is the maximum hardened layer value for heavy-duty gears (category I). This is in contradiction with the prototype [reference 2] data where in order to achieve maximum contact-fatigue strength the hardened layer depth should be Δₚₗ=(0.32-0.45)m.

Δₚₗ=(0.2-0.32)m is the determining factor in selection of the main LH (SH) steel criteria—carbon content and ideal critical hardening diameter for all types of gears. According to thermo-physical calculations, the ideal critical steel hardening diameter for category I gears is D_{cr.}=(1.5-2.0)m, and, based on the accumulated practical experience, carbon content is C=(0.5-1.2)%.

Because of this, for category I gears the hardened layer depth range at the tooth radius and the root is narrowed to Δᵣ=(0.2-0.3)m values that are close to the prototype—Δᵣ=(0.18-0.28)m.

However, as distinct from the prototype, this invention contains a restriction of the actual austenite grain size during TSH to #10-14; this guarantees abrupt decrease in brittleness and improved robustness of gear train components during operation.

Therefore, in case of less loaded fine-modulus gears (categoryII and categoryIII) this factor will make it possible to (See Table 1):

reduce the danger of brittle failure, expand the scope of application of LH steels with higher hardenbility, allow hardening of teeth that is close to through hardening in the pitch circle zone;

increase the hardened layer depth in the roots to 0.45 m (category II) and to 0.9 m (category III), as well as the hardened layer depth up to through hardening (0.2-0.78)m (category II, III) by using LH steels with higher ideal critical diameter values D_{cr.}=(1.5-2.5)m (category II), D_{cr.}=(1.5-3.0)m(categoryI6II) because formation of a hardened layer profile on 3-4.5 mm modulus gears in conformity with category I requirements is difficult due to relatively thin cross sections of the teeth and the lowest possible values of D_{cr.}=6-7 mm; thus, it is expedient that commercially produced LH steels with a D_{cr.}=7-12 mm and D_{cr.}=8-15 mm (category III) be used to produce 3-4.5 mm modulus (category II) gears; the newest steels are capable of consistently meeting the requirements of category I gears with a higher than 5 mm modulus;

reduce the maximum gear surface hardness from 65HRC (category I) to 61HRC (category II, category III) and bring down the lower carbon content limit in LH steels to 0.35% (category III).

Transposition of m>5 mm modulus gear train components from category I to category II and category III at lower loads is practically possible, but economically not cost-efficient because more alloyed LH or SH steels with deeper hardenability should be used for this purpose.

The fact that primary cracks originate not on the surface itself, but rather at some distance from it—in the zone of maximum tangential stresses from an external load—also improves contact-fatigue strength, not taken into account in the prototype [reference 2].

Therewith, the depth below the surface at which maximum tangential stresses occur is calculated by a formula given in [reference 8]:

Δ_{τmax}≈(0.3−0.4)b, where

b is the width of the contact zone of in volute surfaces of the drive and follower gears that is located in the tangential direction. Here, the maximum contact load that leads to contact-fatigue crumbling or “pitting”, is located at the narrow section where the in volute intersects with the pitch line. The effective range of these stresses does not exceed the double depth (2Δ_{τmax}) that is found from the expression:

2Δ_{τmax}≈0.7b

The m=6 mm modulus drive and follower gears (See examples 2 and 3 below) were used to calculate the double depth of action of maximum tangential stresses in heavy-duty and medium heavy-duty conditions, with reference to the modulus (See examples 3.1, 3.2 below):

2Δ_{τmax}=0.08 m—for heavy-duty gears, torsion torque Tₜ₌1440 N·m;

2Δ_{τmax}=0.06 m—for medium heavy-duty gears, Tₜ=714 N·m.

Therefore, in order to achieve higher contact-fatigue strength, in the pitch line zone at the depth from the surface that is not less than 0.08 m for heavy-duty gears and not less than 0.06 m for medium heavy-duty gears the tooth hardened layer microstructure should be as follows:

tempered fine-crystallinemartensite formed during the TSH process with the actual 10-14 grain size per ASTM scale, without structurally-free ferrite or austenite decomposition products—bainite, troostite and sorbite;

0-15% residual austenite with 0.6-1.2% carbon content in LH and SH steels;

superfluous ironcarbides (cementite) with 0.85-1.2% carbon content in LH and SH steels;

carbides of inoculants—titanium, vanadium, zirconium, niobium and tantalum, each no larger than 150 Å;

nitrides of deoxidizers and inoculants—aluminum, titanium, each no larger than 150 Å;

other unavoidable admixtures, each no larger than 150 Å.

In this case the microstructure at the indicated depth within the hardened layer should be homogenous to the maximum extent. Presence of structurally-free particles: ferrite and austenite decomposition products (bainite, troostite and sorbite) is not allowed. They are micro-zones that weaken the hard and robust martensitic matrix. Residual austenite, superfluous carbon carbides in indicated quantities occur after TSH in LH and SH steels with 0.6-1.2% carbon content. Carbo-nitrides of deoxidizers and inoculants are formed when they are added to steel during smelting in order to reduce the grain size during TSH.

Monotonically growing troostite inclusions (0-50%) occur at a bigger depth—up to the hardened layer-core interface (half-martensite zone).

Treatment at cold temperatures, not higher than −60° C. immediately after hardening or low tempering is a supplemental means to improve the contact and bending fatigue strength of gear teeth made from LH and SH steels with carbon content above 0.6%.

The disadvantage of the known published materials is that they also do not describe the main characteristics of the steel being used: LH (SH) steel ideal critical hardening diameter and carbon content depending on the extent of loading and gear teeth sizes that are determined by the modulus.

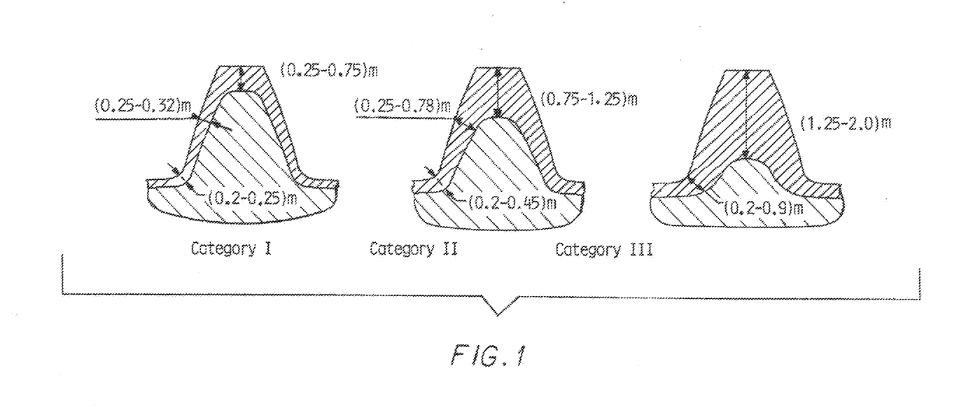

Table 1 and FIG. 1 show the main parameters of category I, category II and category III gear train components case hardened according to the method of the present invention:

the hardened layer depth at the tooth radius and along the root, in the pitch line zone and in the tooth tip depending on the tooth modulus, mm;

tooth surface and tooth core hardness (HRC);

LH and SH steel carbon content;

LH and SH steel ideal critical hardening diameter, mm.

TABLE 1

| | | | | | | | LH and SH |
|---|---|---|---|---|---|---|---|
| | Hardened layer dept, mm | | | | | | steel ideal |
| | At the tooth, | | | | | LH and SH | critical |
| | bottom and | In the pitch | On the tooth | Hardness, | | steel carbon | hardening |
| | along the root, | line zone, | tip, | HRC | | content, | diameterD_{vr · s} |
| Component type, load category | Δᵣ | Δₚₗ | Δₜ | Surface | Core | C, % | mm |
| I. Heavy-duty gears with a m > 5 mm | (0.2-0.25)m | (0.25-0.32)m | (0.25-0.75)m | 56-65 | 30-45 | 0.5-1.2 | (1.5-2.0)m |
| modulus - continuous bending and contact | | | | | | | |
| loads in the vicinity of the σb = 400- | | | | | | | |
| 600N/mm² fatigue point, and bigger | | | | | | | |
| short-term loads | | | | | | | |
| II. Heavy-duty gears with a m = 3-4.5 | (0.2-0.45)m | (0.25-0.78)m | (0.25-1.25)m | 56-61 | 30-45 | 0.5-1.2 | (1.5-2.5)m |
| modulus - continuous bending stresses in | | | | | | | |
| the vicinity of the σ_{b} = 300-600N/mm² | | | | | | | |
| fatigue point | | | | | | | |
| III. Medium-heavy duty gears with an | (0.2-0.75)m | (0.25-0.78)m | (0.25-2.0)m | 50-61 | 30-45 | 0.35-1.2 | (1.5-3.0)m |
| m = 3-4.5 modulus - bending stresses | | | | | | | |
| σb < 300N/mm² | | | | | | | |

m—for cylindrical straight-tooth and skew gears—normal modulus, for bevel gears—average normal modulus.

Example 1. Initial data: modulus m−6mm, outside diameter D_{o.}=108 mm, pitch line diameter Dₚₗ=96 mm, axial tooth height B=70 mm, radial tooth height H≈2.2 m=13.2 mm, tooth thickness at the radius—≈2 m=12 mm, angle between the tooth radius line and the vertical load application axisα≈23°, load application arm sizel≈10.5 mm, load corresponding to the fatigue limit—the horizontal section of the S-N curve with a 10⁷ cycle base,

P=13,000 kg=130,000N.

σ_{bend.}=6 T^{bend.}/Bh², where

T^{bend.}—is the bending torque and T_{bend.}=P/cos α

By substituting the values, we get:

σ_{bend.}=6·13,000·10.50·0.92/70·144=70 kg/mm²=740 N/mm²

Example 2. Finding the automotive follower gear bending stress by testing on a closed loop bench in extreme conditions. Initial data: modulus m=6 mm, outside diameter D_{o.}=300 mm, pitch line diameter D_{pl.}=288 mm, axial tooth heightB=70 mm, radial tooth height H≈2.2 m=13.2 mm, tooth thickness at the radius—≈2 m=12 mm. Torsion torque is:

Tₜₒᵣ=1,440 kg·m=1,440,000 kg·mm=14,400,000 N·mm, rotational speed n=50 rpm.

Maximum bending stress at the tooth pa [symbol] a(σ_{bend.}):

σ_{bend.}=6 T^{bend.max}/Bh², where T_{bend.max}is the maximum bending torque;

T_{bend.max}=P_{bend.}·lₘₐₓ, where

P_{bend.} Is the calculated bending load applied in the zone near the tooth tip;

lₘₐₓ is the maximum arm—a perpendicular line from the contact zone to the tooth radius line;

lₘₐ≈0.9N=12 mm

P_{bend.≈}2T_{tor.}/D_{o.}.

By substituting the values, we get:

σ_{bend.}=1,440,000·2·12·6/300·70·144≈68.5 kg/mm²=685 N/mm²

Example 3. Finding the maximum tangential stress double-depth location(2Δ_{τmax})) in automotive drive and follower gears with a m=6 mm modulus discussed above, in extreme heavy-duty and medium heavy-duty conditions [reference 8]:

3.1. T_{tor.}=1,440 kg·m. Heavy-Duty Conditions.

As shown above, the double depth location of the maximum tangential stresses is:

2Δ_{τmax}≈0.7b, where b is the drive and follower gear in volute surface contact zone.

b=1.5√[(q·2R_{inv.dr}·R_{inv.fol.)}/(R_{inv.dr..}+R_{inv.fol.})·E], where

R_{inv..dr.} is the drive gear in volute radius in the pitch line zone;

R_{inv.fol.} is the follower gear in volute radius in the pitch line zone;

R_{inv.dr.}≈R_{inv.fol.}=R_{inv..}, then b=1.5√q·R_{inv..}/E;

Q is the load per unit of length of contacting cylindrical surfaces;
q=(1.27 P cos α)/B, where P=M_{cr.}/0.5Dₚₗ=M_{cr}/Rₚₗ
α is the angle between the normal to the in volute and the tangent to the pitch line in the point where it intersects with the in volute (the application point of the force P that creates the torque).
For this gear:
m=6 mm,
α=30°,
B (axial tooth length) is B=70 mm,
Dₚₗ, Rₚₗ are the gear diameter and radius along the pitch line,
Rₚₗ=0.144 m,
R_{inv.} Is the in volute radius in the pitch line zone, in most cases, R_{inv.}=(4-5)m, for a 6 mm modulus heavy-duty gear Rᵢₙᵥ=4.5 m
E is the steel modulus of elasticity E≈2,000,000 kg/cm₂≈2·10¹⁰ kg/m². For a 6 mm modulus heavy-duty gear:

b=1.5√1.27Tₜₒᵣ.·cos 30°·4.5 m/Rₚₗ·B·E.

By substituting the values, we get:

b=0.7 mm,

2Δ_{τmax}=0.7b=0.49 mm=0.08 m

3.2. T_{tor.}=714 kg·m. Medium Heavy-Duty Conditions.

Similarly to section 3.1.

b=0.5 mm, 2Δₘₐₓ=0.7b=0.35 mm=0.06 m.

### INCORPORATED BY REFERENCE ARE THE FOLLOWING PUBLICATIONS

1. K. Z. Shepelyakovsky, R. I. Entin et al. Gear surface hardening method. “Bulletin of inventions”. Author's certificate #113770, 1958, #6;

2. K. Z. Shepelyakovsky et al. Gearwheel and gear hardening method. “Bulletin of inventions”. Author's certificate SU#1392115, 1988, #16;

3. K. Z. Shepelyakovsky. [symbol] [symbol] [symbol] [symbol] . M. [symbol] [symbol] , 1972

4. A. A. Kuznetsov, A. M, Peker, I. S. Lerneretal. Process for making low and specified hardenability structural steel. RF patent #2451090, U.S. publication no. US/2013/021384 bul. #14 May 20, 2012;

5. A. A. Kuznetsov, A. M, Peker, I. S. Lerneretal. Process for thermal treatment of parts made from low and specified hardenability structural steel. RF patent #2450060, U.S. publication no. US/2015/0232969 bul. #13, May 10, 2012.

6. A. A. Kuznetsov, A. M, Peker, I. S. Lerneretal. Structural steel for through-surface hardening. RF patent #2450079, U.S. publication no. US/2016/0017468 bul. #13, May 10, 2012.

7. A. A. Kuznetsov, A. M, Peker, I. S. Lerneretal. Process for making low and specified hardenability structural steel. Patent#U.S. Pat. No. 9,187,793B2, Nov. 17, 2015.

8. OrlovP.I.Designbasics. Technical reference guide in 2 books. “Mashinostroenie”, Moscow, 1988

In the claims:

1. canceled

2. canceled

3. canceled

4. canceled

5. A method of making gears of a gear modulus m greater than 5 mm for continuous bending and contact loads in the range of 400-600 N/mm² fatigue point and higher short term loads, comprising making said gears from low hardenability (LH) or specified hardenability (SH) steel having a carbon content of 0.5 to 1.2% and of a critical diameter D_{cr} in mm equal to the gear modulus m times 1.5 to 2.0, and through surface hardening (TSH) said gears so formed,
whereby a hardened depth in mm at the tooth root bottom and radius is equal to 0.2 to 0.25 times the gear modulus m;
a hardened depth in mm at a pitch line is equal to 0.25 to 0.32 times the gear modulus m; and,
a hardened depth in mm at a tooth tip is equal to 0.25 to 0.75 times the gear modulus m; and,
a surface hardness (HRC) at a surface is equal to 56 to 65 and at a gear tooth core equal to 30 to 45.

6. A method of making gears of a gear modulus m from 3 to 4.5 mm for continuous bending loads in the vicinity of 300-600 N/mm² fatigue point, comprising making said gears from low hardenability (LH) or specified hardenability (SH) steel having a carbon content of 0.5 to 1.2% and of a critical diameter D_{cr} in mm equal to the gear modulus m times 1.5 to 2.5, and through surface hardening (TSH) said gears so formed, whereby:
a hardened depth in mm at a tooth root bottom and radius is equal to 0.2 to 0.45 times the gear modulus m;
a hardened depth in mm at the pitch line is equal to 0.25 to 0.78 times the gear modulus m;
a hardened depth mm at the tooth tip is equal to 0.25 to 1.25 times the gear modulus m, and,
a surface hardness (HRC) is equal to 56-61 and at a gear tooth core of 30-45.

7. A method of making gears of a gear modulus m of 3.0 to 4.5 mm for continuous bending in the range of 300 N/mm² fatigue point, comprising making said gears from low hardenability (LH) or specified hardenability (SH) steel having a carbon content of 0.35 to 1.2% and having critical diameter D_{cr} in mm equal to the gear modulus m times 1.5 to 3.0, and through surface hardening (TSH) said gears so formed, whereby:
a hardened depth in mm at the tooth root bottom and a radius equal to 0.2 to 0.75 times the gear modulus m;
a hardened depth in mm at the pitch line equal to 0.25 to 0.78 times the gear modulus m;
a hardened depth in mm at the tooth tip equal to 0.25 to 2.0 times the gear modulus m; and
a surface hardness (HRC) at the surface equal to 50-61 and at a gear tooth core equal to 30-45.

8. The method according to claim 5 wherein with a carbon content in LH or SH steels above 0.6% after TSH said gears are subjected to deep-freeze treatment at temperatures not higher than −60° C.

9. The method according to claim 6 wherein with a carbon content in LH or SH steels above 0.6% after TSH said gears are subjected to deep-freeze treatment at temperatures not higher than −60° C.

10. The method according to claim 7 wherein with a carbon content in LH or SH steels above 0.6% after TSH said gears are subjected to deep-freeze treatment at temperatures not higher than −60° C.

11. The method according to claim 5 wherein on the surfaces to be subjected to TSH, the hardened layer may be either continuous or intermittent.

12. The method according to claim 6 wherein on the surfaces to be subjected to TSH, the hardened layer may be either continuous or intermittent.

13. The method according to claim 7 wherein on the surfaces to be subjected to TSH, the hardened layer may be either continuous or intermittent.

14. The method according to claim 5 wherein the micro structure of the tooth hardened layer in the pitch line zone at the depth of not less than 0.08 m:
fine-crystal line structured tempered martensite formed in the TSH process with the actual grain size #10-14 per ASTM scale, without the structurally free ferrite or austentite decomposition of bainite, troostite or sorbite;
0-15% residual austenite for LH or SH gears with 0.6-1.2% carbon;
nitrides and carbides and nitrides, vanadium carbides and other rare-earth elements; and
0-50% troostite inclusions at the greater depth up to the core/hardened layer boundary.

15. The method according to claim 6 wherein the micro structure of the tooth hardened layer in the pitch line zone at the depth of not less than 0.06 m is as follows:
fine-crystal line structured tempered martensite formed in the TSH process with the actual grain size #10-14 per ASTM scale, without the structurally free ferrite or austentite decomposition of bainite, troostite or sorbite;
0-15% residual austenite for LH or SH gears with 0.6-1.2% carbon;
nitrides and carbides and nitrides, vanadium carbides and other rare-earth elements; and
0-50% troostite inclusions at the greater depth up to the core/hardened layer boundary.
